(19) United States
(12) Patent Application Publication
(10) Pub. No.: US 2010/0242737 A1
(43) Pub. Date: Sep. 30, 2010

(54) ENVIRONMENTAL PROTECTION DOUBLE LAYER OIL SMOKE FILTER DEVICE FOR KITCHEN RANGE

(76) Inventor: Chun-Chi LIU, Banciao City (TW)

Correspondence Address: Muncy, Geissler, Olds & Lowe, PLLC, 4000 Legato Road, Suite 310, FAIRFAX, VA, 22033, US

(21) Appl. No.: 12/415,784

(22) Filed: Mar. 31, 2009

(51) Int. Cl. B01D 46/04

(52) U.S. Cl. 96/233

(57) ABSTRACT

The present invention relates to an environmental protection double layer oil smoke filter device for kitchen range, in which the main body is primarily assembled from a working area, a placement area and a pump water drainage system, while the oil smoke filtering device is assembled from an electrostatic processing device, a draft device and a ventilating device. Accordingly, a pump water drainage system connected to a liquid containing groove located at the bottom portion of the filtering device is used to effectively achieve the facility to separate oil and water within the liquid containing groove, moreover, the separated water can be reused.

### BACKGROUND OF THE INVENTION

(a) Field of the Invention

The present invention provides an oil smoke filter kitchen range, and more particularly provides an environmental protection double layer oil smoke filter device for kitchen range, which apart from being able to effectively use a water net produced by a sprinkler to achieve a clean filtering device, moreover, also effectively enables decreasing the internal temperature.

(b) Description of the Prior Art

With the increasing advancement in science and technology, social needs have grown with each passing day, which has brought increasing responsibility and pressure on modern people, resulting in an increasing number of people dining outside. Accordingly, the increase in people dining outside has led to a corresponding increase in restaurants and more intense competition. Hence, in order to improve business, many restaurants, such as diners, snack bars or roadside vendors, must complete preparation of the food required by the consumer within the shortest time possible. However, the oil smoke processing devices used in such restaurants are extremely simple and crude. Taking diners as an example, the majority use a separated oil smoke processing device to discharge the oil and smoke, but such means is not only expensive to purchase, but also extremely easily causes environmental pollution. Moreover, operators of the majority of the most common roadside vendors or snack bars only install a draft fan at the area where food is prepared to discharge the oil and smoke to an oil smoke pipe, and the oil and smoke is then discharged outdoors or to a sewer, thereby not only causing pollution of the environment, moreover, has a considerable affect on the health of people over a long period of time.

In addition, when cleaning needs to be carried out, the user must disassemble all dependent devices, filter screens and so on, after which a cleaning agent and clear water is separately used to carry out cleaning of the oil from the disassembled equipment, and the oil cleaned off and the water containing the cleaning agent are thrown out. Hence, apart from fouling the surrounding environment, moreover, the cleaning agent not cleaned off and remaining on the equipment will cause the greatest damage to the health of consumers purchasing food over a long period of time without them knowing.

However, the following problems and shortcomings are still in need of improvement when using the aforementioned general kitchen ranges of the prior art:

1. A certain amount of oil and smoke is produced when cooking food, and most general kitchen ranges directly discharge the oil and smoke to the outside or a sewer, thereby causing serious air pollution, which not only results in considerable damage to the health of people, moreover, causes serious pollution of the environment.

2. Because of the oil and smoke produced when cooking, grease particles will adhere to any attachments come across (such as: pipe walls, walls, outside building overhangs, and so on), thereby seriously affecting the surrounding living environment and causing buildings to be deeply ingrained with grime.

3. Many inconveniences result when being assembled by workers, cost of assembly is high, and the kitchen ranges occupy a large working space.

4. When operating, the actual efficiency of removing the oil and smoke is limited in practical use, and is unable to effectively completely remove the oil and smoke particles and peculiar smell.

5. When cleaning, the cleaning agent remaining on utensils cannot be completely cleaned off, thereby affecting the state of health of the consumer.

### SUMMARY OF THE INVENTION

The primary objective of the present invention lies in: An environmental protection double layer oil smoke filter device for kitchen range, which comprises a main body, an oil smoke filtering device, a filtering device, a sprinkler and a water stop device, wherein the main body is primarily assembled from a working area, a placement area and a pump water drainage system, and a liquid containing groove is located at a bottom portion of the filtering device. Moreover, a water inlet pipe, an oil exit pipe, a suction pipe and a drain pipe are separately located at one side of the liquid containing groove. Accordingly, the pump water drainage system is assembled, and the pump water drainage system is able to effectively achieve the facility to separate oil and water within the liquid containing groove, moreover, the separated water can be recycled for use thereof. Furthermore, because a ball float device able to control the amount of water intake is located in the water inlet pipe, thus, clean water can be replenished at any time. In addition, because a plurality of water sprinkle-nozzles are located on the sprinkler, thus, water can be equally distributed on the filtering device and form a water net. Accordingly, apart from being able to clean off grease on the filtering device at all times, moreover, the present invention is able to effectively achieve the facility to decrease the internal temperature, while at the same time, prevent smoldering of the ventilation pipe to avoid a fire from occurring.

Another objective of the present invention lies in: Because an electrostatic processing device, a draft device and a ventilating device are all disposed in a top portion of the main body, thus, the oil and smoke path is shortened, thereby substantially increasing actual working efficiency.

Yet another objective present inventions lies in: The static electricity produced when the electrostatic processing device is operating enables substantially decreasing the oil and smoke particles in the air.

Yet another objective of the present invention lies in: The sprinkler is used to implement a continuous cleaning operation of the filtering device, thus there is no need for a large amount of cleaning agent when carrying out general cleaning.

A further objective of the present invention lies in: The water net produced by the sprinkler is used to implement a first filtering operation of the oil and smoke produced when cooking, thereby completely eliminating the need to discharge the oil and smoke to the outside, and meeting environmental standards to the fullest extent possible.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational schematic view of a preferred embodiment of the present invention.

FIG. 2 is an elevational assembly schematic view of the preferred embodiment of the present invention.

FIG. 3 is an operational assembly schematic view of a liquid containing groove and a pump water drainage system according to the present invention.

FIG. 4 is a flow schematic view of the pump water drainage system according to the present invention.

FIG. 5 is a schematic view depicting an operating state of the preferred embodiment according to the present invention.

FIG. 6 is a schematic view depicting an operating state of another preferred embodiment according to the present invention.

### DETAILED DESCRIPTION OF THE PREFERRED EMBODIMENTS

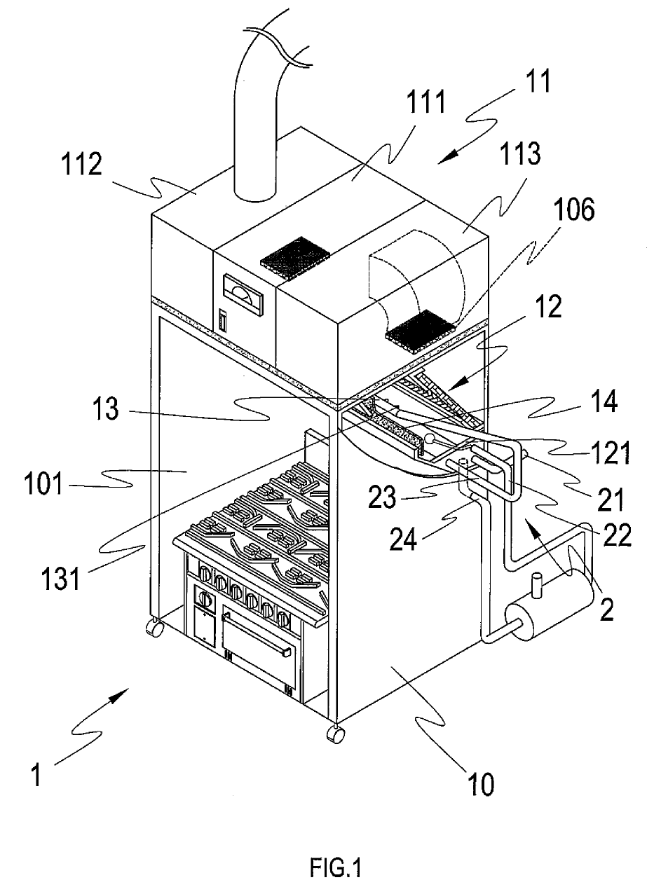

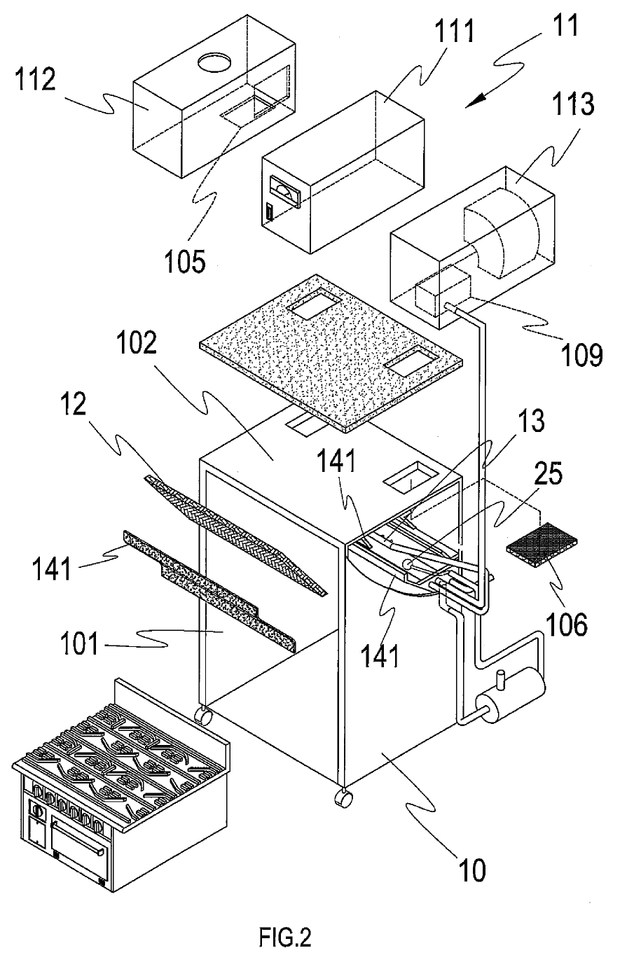

Referring to FIG. 1 and FIG. 2, which show an elevational schematic view and an elevational assembly view respectively of a preferred embodiment of the present invention, and, taking a western-style food stove as an example, it can be clearly seen from the drawings that a double layer oil smoke filter kitchen range 1 of an environmental protection double layer oil smoke filter device for kitchen range of the present invention comprises a main body 10, an oil smoke filtering device 11, a filtering device 12, a sprinkler 13 and a water stop device 14, wherein the main body 10 is primarily assembled from a western-style food stove working area 101, a placement area 102 and a pump water drainage system 2. Furthermore, the oil smoke filtering device 11 is assembled from an electrostatic processing device 111, a draft device 112 and a ventilating device 113. Moreover, an odor filtering ion generator 109 is located within the ventilating device 113, and a liquid containing groove 121 is located at a bottom portion of the filtering device 12. A water inlet pipe 21, an oil exit pipe 22, a suction pipe 23 and a drain pipe 24 are separately located at one side of the liquid containing groove 121. Accordingly, the aforementioned pump water drainage system 2 is assembled, and the pump water drainage system 2 is able to effectively achieve the facility to separate oil and water within the liquid containing groove 121, moreover, the separated water can be reused. In addition, a ball float device 25 able to control the amount of water intake is located in the water inlet pipe 21, thereby enabling clean water to be replenished at all times. Moreover, the sprinkler 13 and the suction pipe 23 are mutually connected, and a plurality of water sprinkle-nozzles 131 are located on the sprinkler 13 at predetermined spacings, thereby enabling the water to be equally distributed on the filtering device 12 and form a water net. In addition, the water stop device 14 is primarily structured from an assemblage of a plurality of sets of water baffle plates 141.

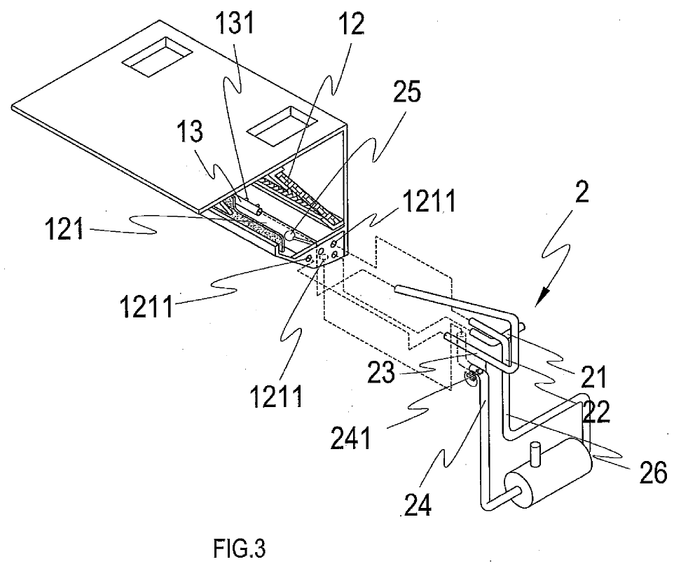

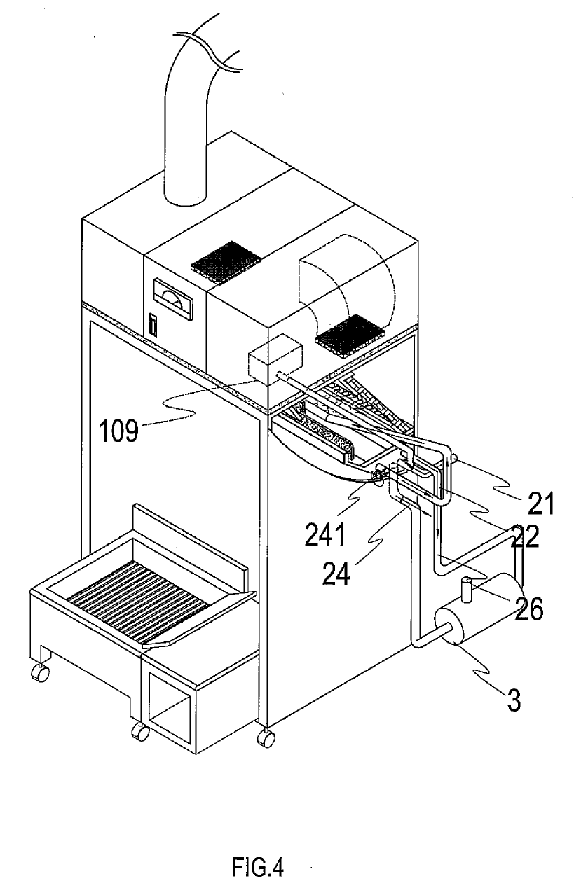

Referring together to FIG. 3 and FIG. 4, and taking a stove as an example, the drawings show an operational assembly schematic view and a flow schematic view respectively of the liquid containing groove 121 and the pump water drainage system 2 of the present invention, and it can be clearly seen from the drawings that first a plurality of through holes 1211 are formed in one side of the liquid containing groove 121, and the water inlet pipe 21, the oil exit pipe 22, the suction pipe 23 and the drain pipe 24 respectively join up with the through holes 1211. Moreover, the suction pipe 23 connects with the sprinkler 13, and a plurality of the water sprinkle-nozzles 131 are located on the sprinkler 13 at predetermined spacings, thereby enabling the water to be equally distributed on the filtering device 12 and form a water net. A water flow control valve 241 able to control whether or not to discharge is disposed within the drain pipe 24 of the aforementioned piping structure forming the pump water drainage system 2. Accordingly, when the user actuates the sprinkler 13, the water sprayed out therefrom carries away the oil on the filtering device 12, and the water and oil is carried along the periphery of the filtering device 12 and drips into the liquid containing groove 121 (as depicted in FIG. 1). Hence, during normal cleaning by the user, the water flow control valve 241 can be closed, thereby enabling the oil to be discharged along the oil exit pipe 22 into an oil collecting container (not shown in the drawings). Because the specific gravity of oil is lighter than water, thus, oil and water automatically separate after dripping into the filtering device 12, thereby eliminating the need for an additional oil filter device.

Furthermore, because the water inlet pipe 21 is fitted with the ball float device 25 able to control the amount of water intake, thus, when external water enters the liquid containing groove 121 through the water inlet pipe 21 (as depicted in FIG. 1), then the ball float device 25 is used to know the amount of water within the liquid containing groove 121 (as depicted in FIG. 1), which enables the supply of water to be actuated or stopped at any time, thereby avoiding an excessive amount of water from entering, resulting in an overflow and causing inconvenience in use.

In addition, because the ventilating device 113 is internally fitted with the odor filtering ion generator 109, and the ion generator 109 connects with the interior of the liquid containing groove 121, thus, a structure is achieved enabling decomposition of odor molecules in the internal air, and realizes the effectiveness of further purification of polluted air.

According to what has been described above. the drain pipe 24 and the oil exit pipe 22 converge to a delivery pipe 26 connected to a water pump motor 3, and the water pump motor 3 is used to send water to the end of the suction pipe 23; the polluted water originally positioned in the liquid containing groove 121 is then redrawn back to the liquid containing groove 121 and mixed with clean water pumped in from the water inlet pipe 21. The suction pipe 23 is then used to draw the liquid within the liquid containing groove 121 into the sprinkler 13, at which time the plurality of water sprinkle-nozzles 131 on the sprinkler 13 are used to spray the liquid on to the filtering device 12. Accordingly, repeated operation of the aforementioned flow procedure does not only prevent wastage of water resources, but also effectively achieve a cleaning effect.

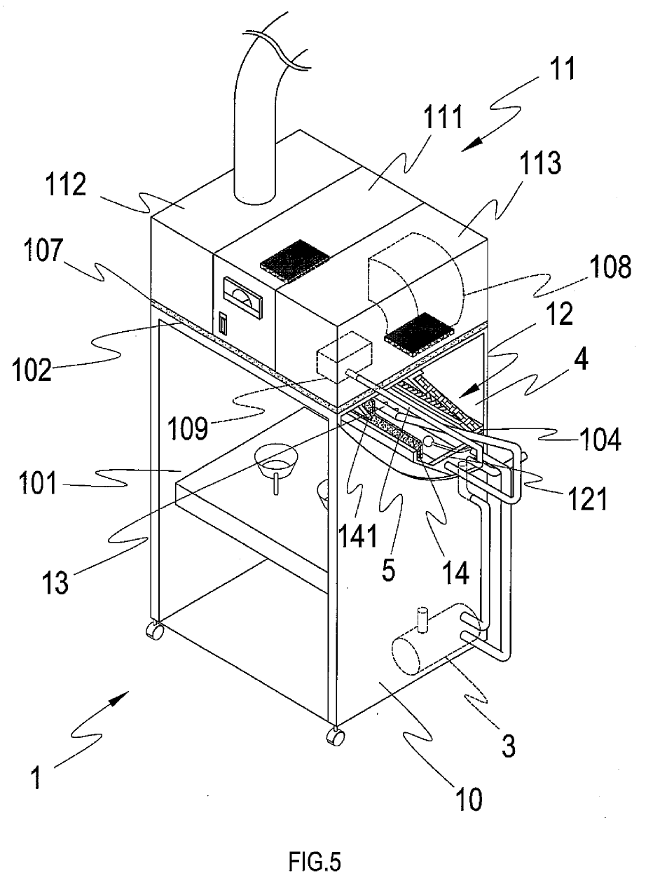

Referring to FIG. 5, taking a stir fryer as an example, the water pump motor 3 is installed interior of the main body 10, and the drawing shows a schematic view of a preferred embodiment depicting an operating state of the present invention, and it can be clearly seen from the drawing that the oil smoke filtering device 11 of the present invention is assembled from the electrostatic processing device 111, the draft device 112 and the ventilating device 113, wherein the ventilating device 113 is fitted with a ventilation pipe 108 and the oil filtering ion generator 109. The ion generator 109 connects with the interior of the liquid containing groove 121, thereby achieving a structure able to decompose odor molecules in the interior air, and the oil smoke filtering device 11 is installed atop the main body 10. Moreover, an anti-static electroplate 107 disposed on the placement area 102 enables preventing static electricity from occurring. Because support portions 104, enabling mutual connection between the filtering device 12 and the working area 101, are located at an upper portion of the working area 101, thus, the support portions 104 can be used to fixedly secure the filtering device 12 to the top portion of the working area 101 and close to the bottom portion of the placement area 102. Moreover, the support portions 104 are inclined at a predetermined angle, and a first vacuum pressure area 4 is formed between the filtering device 12 and the working area 101. Furthermore, the sprinkler 13 is fitted at one side of the filtering device 12 and internally thereof, and the water stop device 14 is fitted to one side close to the sprinkler 13. The water stop device 14 is primarily structured from an assemblage of a plurality of sets of the water baffle plates 141, thereby enabling a second vacuum pressure area 5 to be formed between the water stop device 14 and the filtering device 12. Accordingly, the oil and smoke treatment efficiency is effectively increased.

Referring again to FIG. 2, air vents 105 are respectively formed in the placement area 102 close to two side ends of the working area 101, and the air vents 105 are respectively fitted with water baffles 106 close to one end of the western-style food stove. Moreover, the water baffles 106 are of honeycomb form, thereby enabling the water baffles 106 to prevent water or oil from splashing into the oil smoke filtering device 11 and causing a breakdown when the sprinkler 13 sprays water.

From the aforementioned it can be known that the large amount of oil and smoke produced when a user is cooking is absorbed by the draft device 112 through the air vent 105 into the ventilation pipe 108 within the ventilating device 113. At this time the oil and smoke is passing through the electrostatic processing device 111. and because the electrostatic processing device 111 uses electrostatic precipitation means, in which electrostatic precipitation uses the principle of mutual attraction of opposite charges, and an external high pressure is used to form an electric field with two opposite poles, thus, under a Coulomb force function, the oil smoke particles are made to be electrically charged, after which they move towards a collecting plate and adhere thereto. Accordingly, the electrostatic processing device 111 filters the oil and smoke to form clean air, thereby achieving the objective of purifying air.

After filtering, the air is discharged to the outdoor air through the draft device 112, thereby not only creating a clean and fresh environment, but also eliminating the need for overuse of cleaning agents when cleaning, while at the same time gives consideration to the concept of environmental protection.

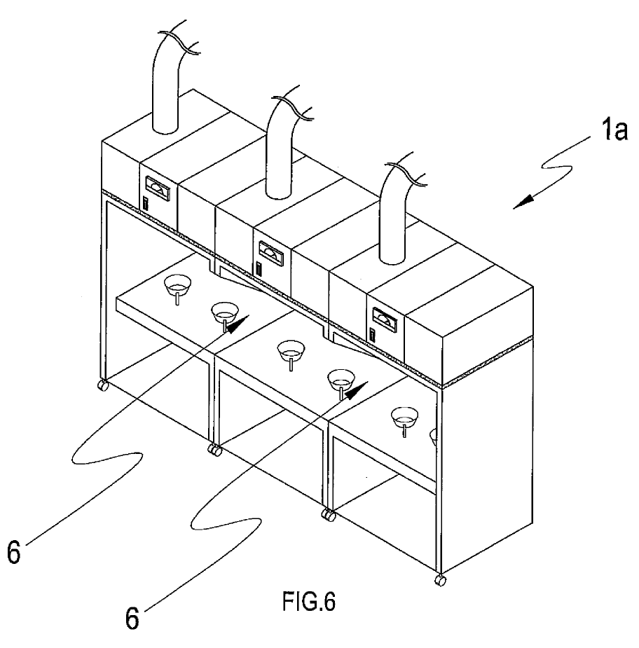

Referring to FIG. 6, which shows a schematic view depicting an operating state of another preferred embodiment according to the present invention, and it can be clearly seen from the drawing that when double layer oil smoke filter kitchen ranges 1a are installed in a location which is relatively wide, then the double layer oil smoke filter kitchen ranges l a can be fixedly locked together using series connection means, thereby causing an opening 6 to be defined in the area between where each of the double layer oil smoke filter kitchen ranges 1a are joined together, thus creating a wider working range and facilitating cooking.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An environmental protection double layer oil smoke filter device for kitchen range, comprising:
a main body, the main body is assembled from a working area, a placement area and a pump water drainage system;
an oil smoke filtering device, the oil smoke filtering device is installed to the placement area;
a filtering device, the filtering device is located at a top portion of the working area and close to the bottom portion of the placement area, moreover, the filtering device is inclined at a predetermined angle;
a sprinkler, the sprinkler is disposed at one side of the filtering device and close to a western-style food stove, moreover, one end of the sprinkler connects with a pump water drainage system; and
a water stop device, the water stop device is disposed close to one side of the sprinkler.

2. The environmental protection double layer oil smoke filter device for kitchen range according to claim 1, wherein a liquid containing groove is located at a bottom portion of the filtering device of the working area.

3. The environmental protection double layer oil smoke filter device for kitchen range according to claim 2, wherein one side of the liquid containing groove is fitted with the pump water drainage system, comprising:
a water inlet pipe, the water inlet pipe is connected with a ball float device able to control the amount of water intake;
an oil exit pipe, a water flow control valve able to control whether or not to discharge is disposed within the drain pipe, and close to the water inlet pipe;
a suction pipe, the suction pipe draws out liquid within the liquid containing groove, and is close to the oil exit pipe; and
a drain pipe, the drain pipe and the oil exit pipe converge to a delivery pipe connected to a water pump motor.

4. The environmental protection double layer oil smoke filter device for kitchen range according to claim 1, wherein air vents, provided with water baffles assuming honeycomb form, are respectively formed in the placement area close to two side ends of the working area.

5. The environmental protection double layer oil smoke filter device for kitchen range according to claim 1, wherein an anti-static electroplate is disposed on the placement area.

6. The environmental protection double layer oil smoke filter device for kitchen range according to claim 1, wherein water sprinkle-nozzles are located on the sprinkler at predetermined spacings facing the filtering device.

7. The environmental protection double layer oil smoke filter device for kitchen range according to claim 1, wherein the water stop device is structured from an assemblage of a plurality of sets of water baffle plates.

8. The environmental protection double layer oil smoke filter device for kitchen range according to claim 1, wherein a first vacuum pressure area is formed between the filtering device and the working area, and a second vacuum pressure area is formed between the water stop device and the filtering device.

9. The environmental protection double layer oil smoke filter device for kitchen range according to claim 1, wherein support portions connecting with the working area extend from two sides of the filtering device.

10. The environmental protection double layer oil smoke filter device for kitchen range according to claim 1, wherein the oil smoke filtering device comprises:
an electrostatic processing device, the electrostatic processing device is installed at a central position of the placement area;
a draft device, the draft device connects with one side of the electrostatic processing device; and
a ventilating device, the ventilating device is disposed at another side of the electrostatic processing device.
